(19) United States
(12) Patent Application Publication
(10) Pub. No.: US 2007/0073776 A1
(43) Pub. Date: Mar. 29, 2007

(54) Digital file management

(76) Inventors: Steven Paul Kalalian, New York, NY (US); Aaron Henry Holm, Brooklyn, NY (US)

Correspondence Address: FISH & RICHARDSON P.C., P.O. BOX 1022, MINNEAPOLIS, MN, 55440-1022, US

(21) Appl. No.: 11/523,115

(22) Filed: Sep. 18, 2006

Related U.S. Application Data
(60) Provisional application No. 60/718,830, filed on Sep. 19, 2005.

(51) Int. Cl. G06F 17/00

(52) U.S. Cl. 707/104.1

(57) ABSTRACT

An enterprise-level, digital asset management system enables users to upload digital assets (e.g., digital image files) to a central on-line site and to view, edit, manage, arrange, organize, annotate and adjust the digital images. Multiple parties can communicate and collaborate with one another in real-time in connection with a project involving the digital images. The images can be stored, archived, edited, sorted and sent using a central web-accessible workspace that can be accessed remotely by the various persons working on the project. Users (e.g., clients) can order post-production services such as file processing, direct print output, downloads to media, file transfers, file archiving and retrieval. The system can be fully automated to allow users to access their digital assets independently, as well as order and pay for services through a built-in ordering component. The system can consolidate all aspects of the digital photography workflow.

### CROSS-REFERENCE TO RELATED APPLICATION(S)

This application claims the benefit of priority of U.S. Provisional Patent Application No. 60/718,830, filed on Sep. 19, 2005. The disclosure of that application is incorporated herein by reference.

### BACKGROUND

Digital imaging management can include a wide range of processes such as capturing the digital images, processing the images and delivering the finished images. Many individuals with different roles may be involved in various aspects of the process. In addition, the individuals who are collaborating on a particular project often are in different geographical locations.

For example, in the context of a digital photograph shoot, the parties involved may include the photographer, the talent, the art director and the client. Each of those parties may be in a different geographical location, yet they may need to collaborate on certain aspects of the project. Thus, while the photographer may be at the site of the shoot, the art director, whose input is required as the shoot proceeds, may be located far away in a different part of the world.

The present disclosure relates to techniques and systems that facilitate the storage, processing and delivery of digital images and other digital files, and addresses the technical issues of how to facilitate real-time collaboration by multiple parties who may be in different locations.

### SUMMARY

As described in greater detail below, an enterprise-level, digital asset management system enables users to upload digital assets (e.g., digital image files such as photographs) to a central on-line site and to view, edit, manage, arrange, organize, annotate and adjust the digital images. Multiple parties can communicate and collaborate with one another substantially in real-time in connection with a project involving the digital images. The images can be stored, archived, edited, sorted and sent using a central web-accessible workspace that can be accessed remotely by the various persons working on the project. Users (e.g., clients) can order post-production services such as file processing, direct print output, downloads to media, file transfers, file archiving and retrieval. The system can be fully automated to allow users to access their digital assets independently, as well as order and pay for services through a built-in ordering component. Thus, the system can consolidate various aspects of the digital photography workflow.

In one aspect, an digital asset management system includes a file storage module to store digital asset files, a data upload module to upload digital asset files for storage in the file storage module, and a user interface module to give users selective access, through a computer network, to digital asset files stored in the file storage module. The user interface module allows various users to take specified actions with respect to the digital asset files depending on respective privileges granted to each user and stored by the system.

The digital asset files can be digital image files or other digital assets.

Various implementations can include one or more of the following features. For example, the user interface module, which can be accessible through an Internet website, can allow various users to view, search, sort, rank, compare side-by-side, edit or annotate the digital image files depending on respective privileges granted to each user and stored by the system.

The system can be configured to store rankings, edits and annotations made by users to the digital image files. Rankings, edits or annotations made by a first user can be made available for viewing, through the user interface module, by another user who has appropriate privileges.

The user interface module can be configured to display a screen that includes: (i) an image library to allow the user to navigate through collections of image files, (ii) an image gallery in which a collection of image files selected by the user from the image library are displayed, and (iii) an image preview section for displaying a larger size view of a particular one of the image files selected by the user from among the image files displayed in the image gallery.

The user interface module can be configured to cause selected digital image files to be displayed on a user's display screen in accordance with a user-selected format, which is selected from among at least the following available options: a thumbnail view of the selected digital image files, a listing of records corresponding to the selected digital image, and a view of the selected digital image files that includes associated metadata for each of the displayed files. The user interface module can be configured to display a subset of image files based on a user-selected filter applied to a collection of image files selected by the user.

The user interface module also can be configured to display editing tools that allow a user to mark-up a displayed image and to enter text notes on a displayed image. The system can be configured to store such mark-ups and text notes and to make them available for viewing through the user interface module by another user who has appropriate privileges. In some implementations, the editing tools allow the user to select a color and brush size for the mark-ups. The system can be configured to apply the color and brush size selected by the user to the displayed image.

The user interface module can include a magnification tool that allows the user to select a scaled view of the displayed image. The size of the mark-ups and text notes scale with the size of the displayed image as the user uses the magnification tool. The system can be configured to save the mark-ups and text notes and to apply them to a high resolution image file corresponding to the displayed image in response to input from the user.

The user interface module also can be configured to display color management tools to allow a user to adjust one or more of the following with respect to a displayed image: color curves, RGB values and image exposure values. The system can be configured to modify the displayed image in accordance with user-specified changes based on the color management tools. The system can be configured to save color curves, RGB values and image exposure values entered by the user and to apply them to a high resolution image file corresponding to the displayed image in response to input from the user.

The user interface module can be configured to allow the user to store one or more user-selected image files in a user-defined electronic folder. Furthermore, the user interface module can be configured to display a pop-up window in response to user-input to allow the user to send contents of the user-defined folder by e-mail to a third-party. The pop-up window can provide options for the user to define what privileges the third-party will have with respect to the contents of the folder. The system can be configured to monitor and update contents of the folder dynamically in accordance with changes made by the third-party. The user interface module also can be configured to allow the user to store one or more selected image files in an electronic shopping cart and to order post-production services related to the selected images.

The user interface module can be configured to allow user to view enlarged versions of user-selected image files in a side-by-side comparison mode. The user interface module also can include a loupe tool to allow the user to view an enlarged version of a selected portion of one of the selected image files in the side-by-side comparison mode.

The user interface module can be configured to download one or more user-selected image files from the file storage module to a local cache associated with the user in response to a request from the user.

In some implementations, the user interface module includes a metadata editor interface to allow a user to enter metadata for storage by the system in association with a specified image. The system can be configured to implement an Extensible Markup Language (XML) message-oriented web technique for saving and retrieving Extensible Metadata Platform (XMP) image metadata.

The data upload module can be configured to upload a set of digital image files over a network in real-time as the digital image files are captured by digital photographic equipment. In addition, a data pre-processing module can apply user-selected format, resolution and metadata transformations to user-selected digital image files. Available transformations in the data pre-processing module can include, for example, scaling and converting the digital image files to a low resolution format; scaling and converting the digital image files to a high resolution format; copying XMP metadata; embedding metadata using a template; and extracting metadata and providing output to metadata files. The data pre-processing module can be configured to synchronize the uploaded digital image files according to one or more predetermined formats.

The system can be implemented as an on-line system that provides users access to the images, for example, via an Internet website. In some implementations, the system (or parts of the system) may be implemented in a closed network environment.

Other aspects include a computer-implemented method and an article comprising a machine-readable medium that stores machine-executable instructions for causing a machine to implement the method.

The details of one or more embodiments of the invention are set forth in the accompanying drawings and the description below. Other features and advantages of the invention will be apparent from the description and drawings, and from the claims.

### BRIEF DESCRIPTION OF DRAWINGS

FIG. 1 is a block diagram illustrating an example of a digital asset management system according to the invention.

FIG. 2 is an example of a screen that includes an image library, an image gallery and an image preview section.

FIG. 3 is an example of a screenshot in which the image gallery is shown in a “list” view.

FIG. 4 is an example of a screenshot in which the image gallery is shown in a “metadata” view.

FIG. 5 illustrates an example of an image editor pop-up window.

FIG. 6 illustrates an example of the image editor pop-up window with multiple images shown in a comparison mode.

FIG. 7 shows the image editor pop-up window including a loupe tool.

FIGS. 8 and 9 show the image editor pop-up window including editing tools.

FIGS. 10-12 illustrate the image editor pop-up window including color management and processing tools.

FIG. 13 is an example of a screen that illustrates search capabilities.

FIG. 14 shows an example of search results.

FIG. 15 is an example of a screenshot that illustrates a “lightbox” folder view.

FIG. 16 illustrates the lightbox folder view including an e-mail pop-up window.

FIG. 17 is an example of a screenshot that allows a user to place an order for services.

FIG. 18 illustrates a metadata editor interface.

Like reference symbols in the various drawings indicate like elements.

### DETAILED DESCRIPTION

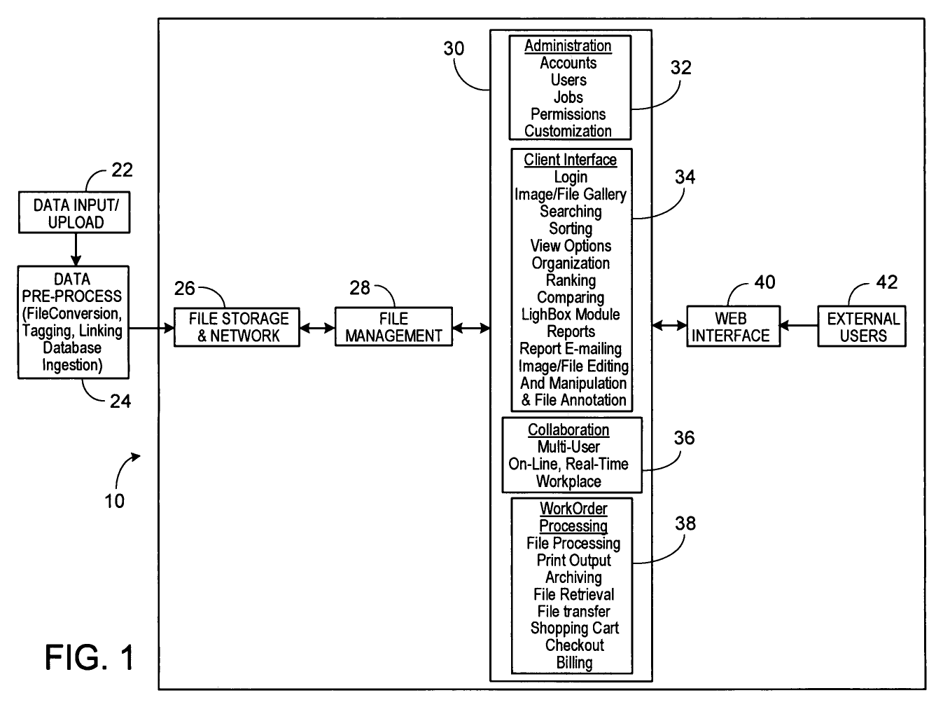

FIG. 1 illustrates a block diagram of an implementation of a digital asset management system 20. The system includes various modules, each of which may be implemented in hardware, software or a combination of hardware and software, and may include, for example, one or more databases and servers. The various modules may be implemented separately or they may be integrated, depending on the particular needs of the system. Some features of the system can be implemented in computer programs executing on programmable computers. Each program can be implemented, for example, in a high level procedural or object-oriented programming language to communicate with a computer system. Furthermore, each such computer program can be stored on a storage medium, such as memory readable by a general or special purpose programmable computer or processor, for configuring and operating the computer when the storage medium is read by the computer to perform the functions described.

The system 20 includes a data input/upload module 22, which allows digital files to be uploaded to the system. Although the particular implementation described below focuses on digital image files such as digital photographs, various implementations may incorporate other types of digital files including, for example, data files, video files, audio files and application files. In some implementations, the digital files can be uploaded directly to a file server. Other implementations may use a remote upload, for example, via the Internet or other network. A data pre-processing module 24 performs such processes as tagging the uploaded files with metadata and keywords, creating preview images from raw and high resolution image files, and linking the preview and high resolution files. The system includes a file storage and network module 26 as well as a file management module 28.

A main module 30 has several sub-modules that allow users to interact with the system. The main module 30 includes an administration sub-module 32, a client or user interface sub-module 34, a collaboration sub-module 36 and a work order processing sub-module 38. The administration sub-module 32 allows an administrator to establish accounts, jobs and permitted activities for individual users. The client or user interface sub-module 34 allows a user to log into the on-line system, view image files stored in the system, search and sort image files, view options, rank or compare image files, store selected image files in separate folders, and edit and annotate image files, among other functions. The collaboration sub-module 36 allows multiple users of the system effectively to share an on-line workspace in real-time. The work order processing sub-module 38 allows a user to place selected image files in an electronic shopping cart and to place orders for prints of the selected files.

A web-interface module 40 allows users using external devices 42 (e.g., personal or laptop computers) to access the system 10 through a website on the Internet or other network. User applications residing on the external devices 42 may include, for example, an Internet browser, a file transfer protocol (FTP) client application, e-mail and a virtual private network (VPN) for approved client access.

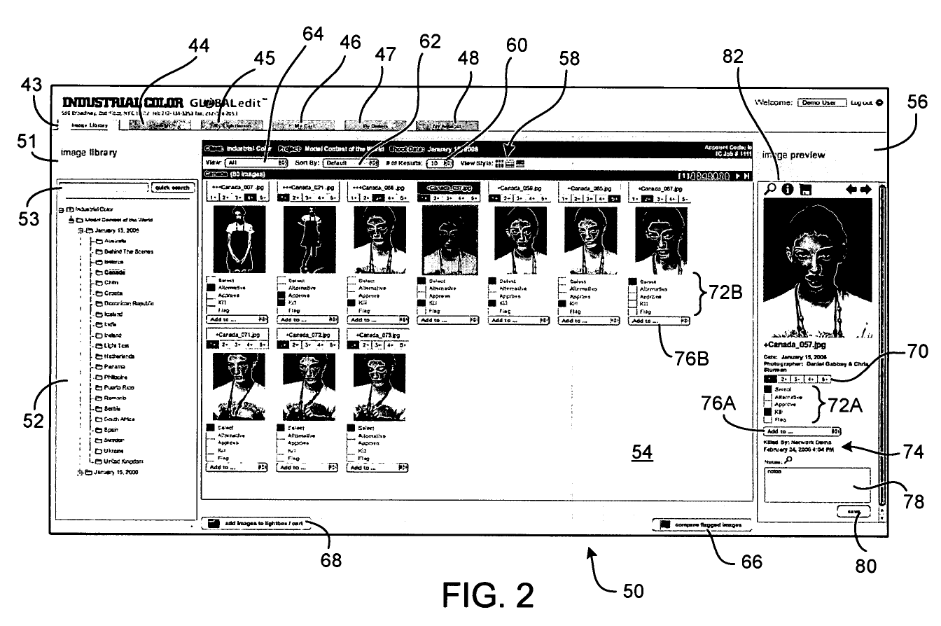

FIGS. 2 through 13 illustrate examples of various screenshots that allow a user to access, manipulate and manage its image files. Once the user logs in, the system 20 provides customized access and views based on parameters established for that user by a system administrator. As shown in FIG. 2, after logging in, the system provides a screenshot 50 that has several tabs (43 through 48) that allow the user to select the various functions available from the system. In the illustrated example, the default view corresponds to tab 43, labeled “Image Library.” Other tabs are labeled “Search” tab 44, “My Lightboxes” tab 45, “My Cart” tab 46, “My Orders” tab 47 and “My Account” tab 47. The screen view for administrative users may include an additional tab labeled, for example, “Administration” (not shown in FIG. 2).

As shown in FIG. 2, the screenshot 50 is divided into three section: an image library section 51, an image gallery section 54, and an image preview section 56.

The image library section 51 displays a job tree 52. The job tree provides a hierarchical listing of jobs, shoot dates, shots and images. The user can navigate through the job tree 52 and select a particular job, shoot date or shot by moving the cursor on the computer screen display to a particular item and clicking on that item. An electronic mouse or similar device can be used to move the cursor to the desired area of the screen. A user can search for a particular item in the job tree 52 by entering the name of the individual file or collection of files into a search area 53, and clicking the adjacent “quick search” button.

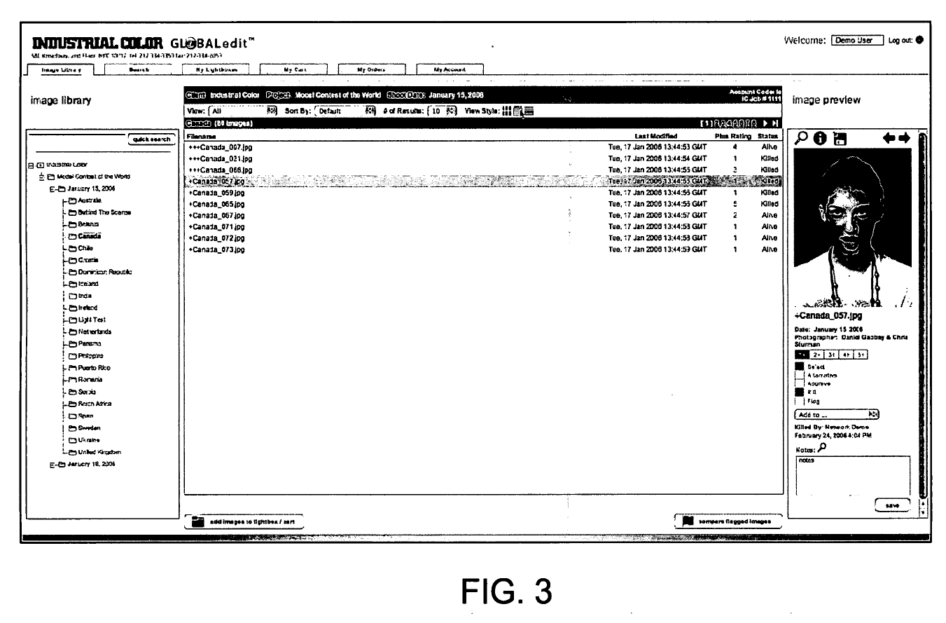

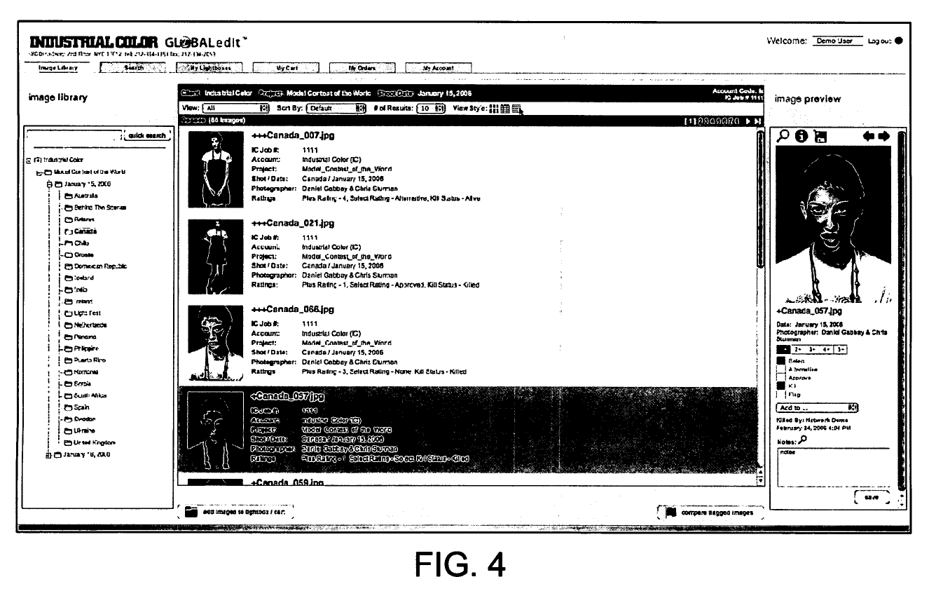

The screen 50 allows the user to select one of several views in which the selected image files are presented in the image gallery section 54 by moving the cursor and clicking on one of several icons 58 that appear in the screen. The default view, which is shown in FIG. 2, is a thumbnail presentation of the images. Other views that can be provided include a listing of the image files (FIG. 3) and a metadata view of the images (FIG. 4). The metadata view allows the user to view the image of each selected file together with certain metadata related to the image. In the illustrated implementation, the metadata includes a job identifier, an identification of the account, a description of the shot and the shoot date, the name of the photographer and rating or other status information entered by one or more users. Other metadata may be listed in various implementations.

The image preview section 56 displays a medium size view of a particular one of the images that can be selected, for example, by clicking on that image in the image gallery 54. In the illustrated implementation, the image preview section 56 is present regardless of which view of the image gallery 54 is selected (e.g., thumbnail, list or metadata).

The user can enter various information into the system in connection with a particular image in the image preview section 56 (FIGS. 2, 3 or 4) or with respect to an image in the default view of the image gallery section 54 (FIG. 2). For example, the user can click on one of the boxes 70 in the image preview section 56 so as to rank or score the image on a scale of one to five. Another group of boxes 72A allows the user to indicate an action that is to be taken with respect to the particular image. In the illustrated implementation, possible actions include “select,” “alternate,” “approve,” “kill” and “flag.” The boxes labeled “select,” “alternate,” “approve” and “kill” also reflect a form of user ratings. For example, a user may wish to indicate that a particular image is approved for use in the particular project or that the image is “killed” and should not be considered for use in the project. Additional groups of boxes 72B appear beneath each image in the default view of the image gallery 54 (FIG. 2). The functions of the boxes 72B is the same as the function of the corresponding boxes 72A in the image preview section 56. If the box labeled “flag” is selected, then the particular image will be acted upon when the “compare flagged images” button 66 (located at the lower right-hand side of the screen) is selected. The functionality of the “compare flagged images” button 66 is discussed below. The image preview section 56 also lists information 74 as to who initiated a particular action with respect to the displayed image and when the action took place.

A drop-down menu 76A in the image preview section 56 allows the user to add the displayed image to one of several folders (e.g., a lightbox or shopping cart, discussed below). Below each image in the default view of the image gallery 54 (FIG. 2) is a drop-down menu 76B that functions in a similar manner to the drop-down menu 76A. Images also can be added to a lightbox or cart by clicking the button 68.

The image preview section 56 also includes an area 78 where the user can enter text notes relating to the image. Information entered in the text notes section 78 can be saved by clicking the “save” button 80 in the image preview section 56. The notes are saved in a database and are tracked so that all notes associated with a particular image can be viewed in a history thread.

The screens of FIGS. 2, 3 and 4 include drop-down menus that allow the user to apply one of several filters and sorting arrangements to the content that appears in the image gallery 54. In the default mode, information for all the images in the selected section of the image library 52 are displayed in the image gallery 54. However, the drop-down menu 64 labeled “view” allows the user to limit the images that appear in the gallery 54 based on criteria selected by the user. For example, the images can be filtered according to the ranking applied to the image or according to some other status information applied to the images (e.g., “selected,” “alternative,” “approved,” “killed,” “not killed” or some combination of those choices). Similarly, the user can select the order in which the image information appears in the image gallery 54 by using the “sort by” drop-down menu 62. For example, the image information can be sorted so that the images in the gallery section 54 appear in order of ranking or other status information. The upper limit on the number of images that appear in the gallery section 54 can be selected using a drop-down menu 60 labeled “# of results.”

By clicking on the “compare flagged images” button 66 (FIGS. 2, 3 and 4), the system displays selected images to allow side-by-side comparison. The images can be selected for inclusion in the side-by-side comparison by clicking on the boxes 72A (or 72B) labeled “flag” corresponding to the desired images.

The system also includes an image editor that provides various tools to allow a user to view magnified versions of the images and to make annotations and mark-ups on the image or to make various color or other changes to the image. The image editor is presented as a pop-up window that appears on the user's display screen and can be implemented, for example, using Macromedia Flash 8.0 available from Adobe Systems, Inc. The interface can be developed in the Macromedia Flash authoring environment, and the client interface can be accessed via the free Flash Player. The image editor interface allows the user to interact with content. Data is sent from the Flash interface to appropriate web services as the user marks selects, edits metadata, adds markups and color edits, as explained below.

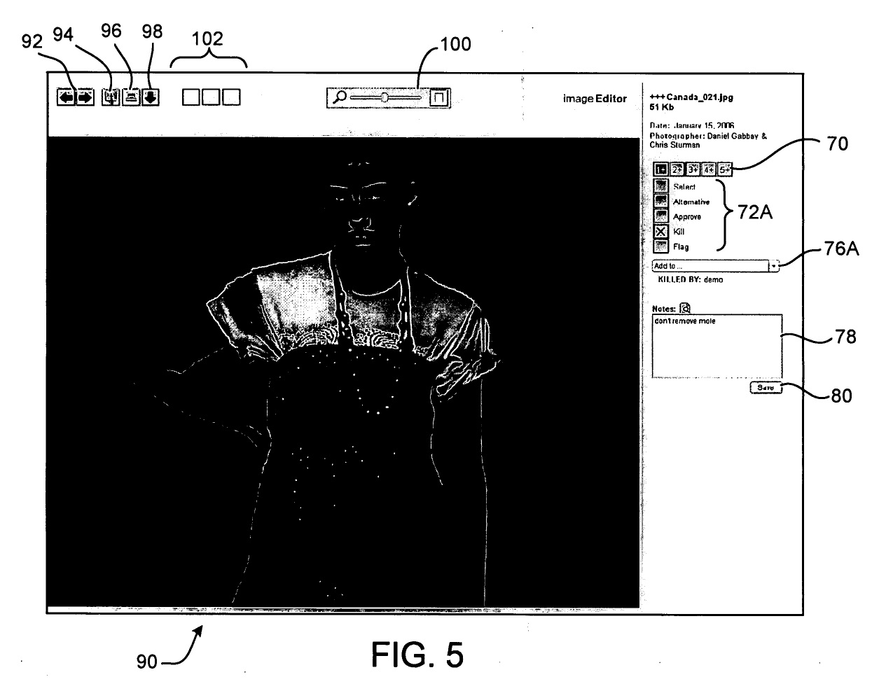

The image editor can be accessed in one of several ways, for example, by double clicking the cursor on a particular image in the image preview section 56 or by double clicking on the particular image or record for the image in the image gallery 54. Alternatively, the image editor can be accessed by clicking on the magnifying glass icon 82 that appears in the image preview section 56. An example of a pop-up window 90 showing the image editor is illustrated in FIG. 5.

In the illustrated implementation, the image editor includes a tool bar with several buttons and icons that allow the user to perform various functions. A pair of buttons 92 allows the user to scroll backwards to a previous image or forwards to a subsequent image. An icon 94 allows the user to download the displayed image to a local cache where the user is located. Similarly, another icon 98 allows the user to download all the images from the particular shot, including the displayed image, to a local cache. The functionality provided by the icons 94, 98 allows a client to work with its images in a local environment over the Internet. Thus, for example, all the images from a particular photo shoot can be preloaded into the client's local machine cache so that the client can work with the images locally, thereby obviating the need for the client to wait while each image is loaded individually. Any notes or modifications to the locally loaded images applied during off-line editing subsequently can be synchronized with the information stored by the system. Another icon 96 on the image editor can be used to print the displayed image.

The image editor includes additional features. For example, a magnification button 100 allows the user to magnify the displayed image. To view a particular portion of the enlarged image, the user can drag and drop the image in the pop-up window using an electronic mouse or similar device until the desired portion appears in the window.

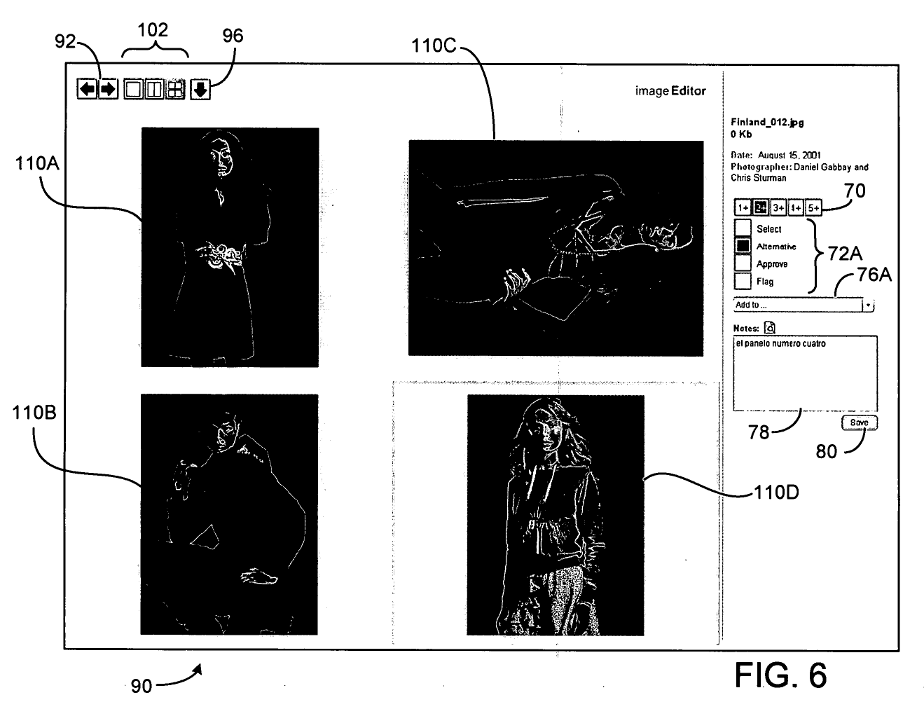

In some implementations, additional icons 102 are available in the image editor pop-up window to allow the user to compare two or four images in the same window. As mentioned above, the images retrieved for side-by-side comparison can be selected by checking the appropriate “flag” boxes 72A or 72B for the desired images (see, e.g., FIG. 2). An example of the image editor pop-up window with four images 110A, 110B, 110C, 110D is illustrated in FIG. 6.

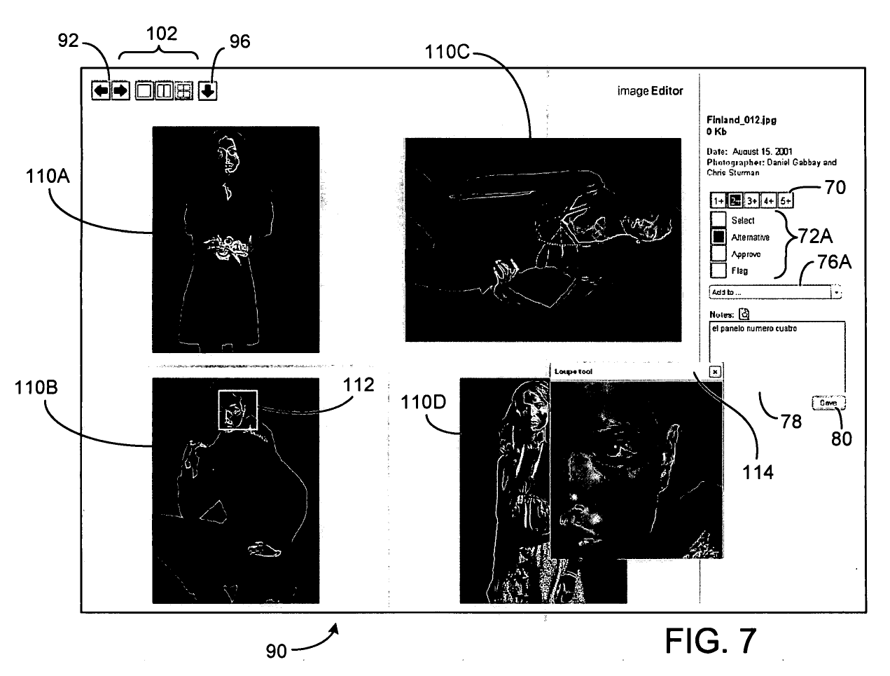

A loupe tool allows the user to zoom in on an particular portion of one of the frames displayed in the comparison mode of the image editor pop-up window. The functionality of the loupe tool can be accessed, for example, by clicking on one of the images displayed in the image editor pop-up window, which causes the selected image to be the active frame. As shown in FIG. 7, an enlarged version of a portion 112 of the selected image 110B appears in a loupe tool pop-up window 114. To view a different portion of the selected image in the pop-up window 114, the user can move the cursor to the desired portion of the selected image (e.g., image 110A). To view another one of the images in the loupe tool pop-up window, the user moves the cursor to that image and clicks on the image.

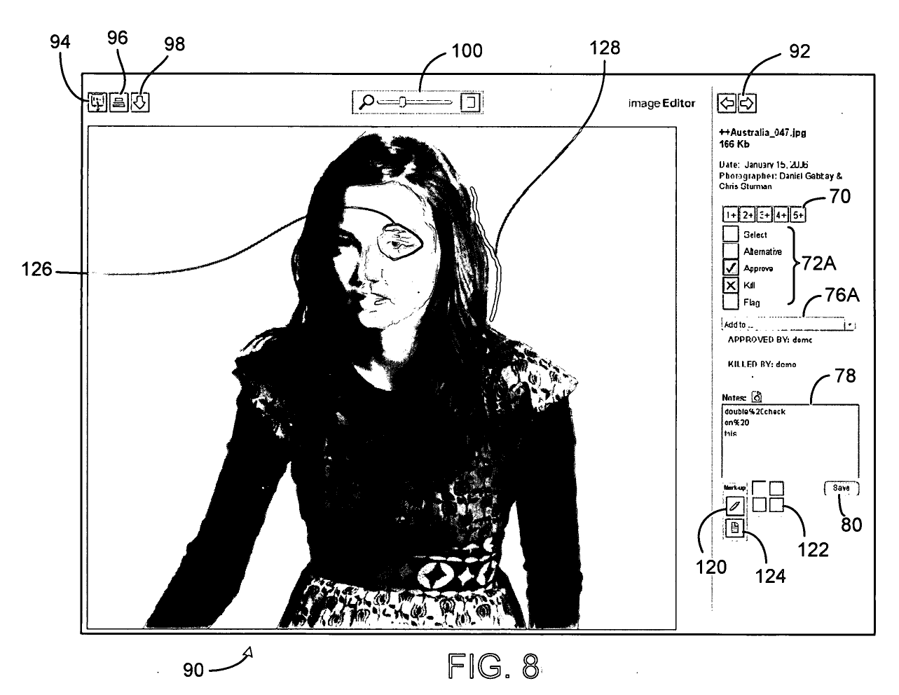

In some implementations, the image editor includes editing tools that allow the user, for example, to mark-up the displayed image and to enter text notes associated with the mark-ups. As shown in FIG. 8, one of the editing tools is a pen 120 that allows the user to draw markings electronically on the preview image displayed in the pop-up window. The user can click on a colored box 122 to select one of several colors in which the markings appear. In some implementations, the editing tool allows the user to select from among several brush sizes. Examples of markings made with the pen 120 are identified by reference numerals 126 and 128. The markings scale with the image when the user uses the magnification tool 100. The markings can be saved to the file for subsequent printing. In addition, the settings for the mark-ups can be saved separately so that they can be applied, for example, to a high resolution image file.

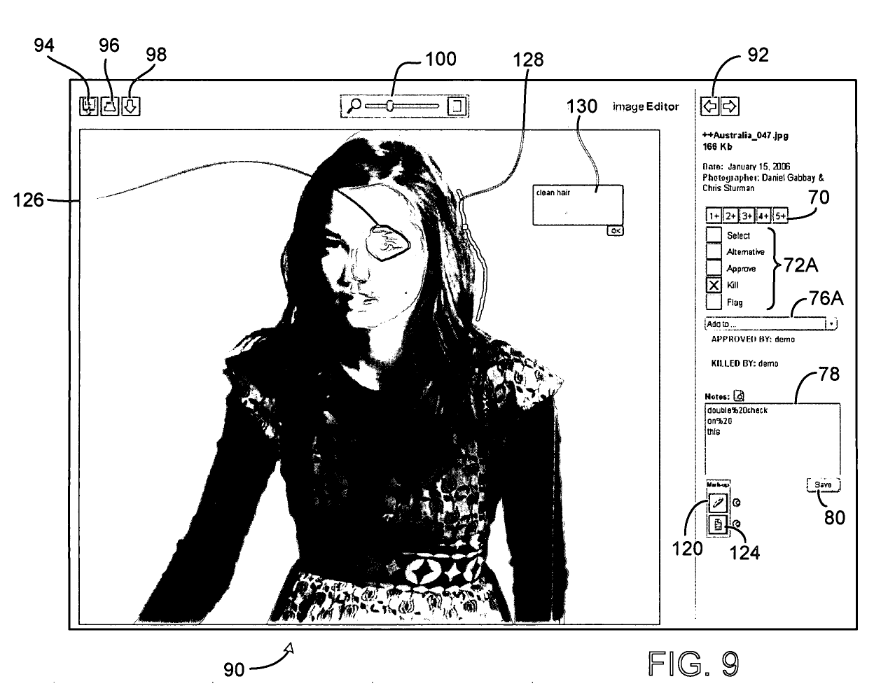

Another icon 124 can be clicked to activate an annotation tool, which allows the user to attach a text note in a dialog box 130 (see FIG. 9). The dialog box 130 can be visually associated with a particular marking (e.g., marking 128) on the image. The system stores the annotations for each user. The annotations appearing on the image scale with the image when the user uses the magnification tool 100. Additionally, users can view the annotation history. Like the mark-ups, the annotations can be saved to the file for subsequent printing and can be saved separately so that they can be applied, for example, to a high resolution image file.

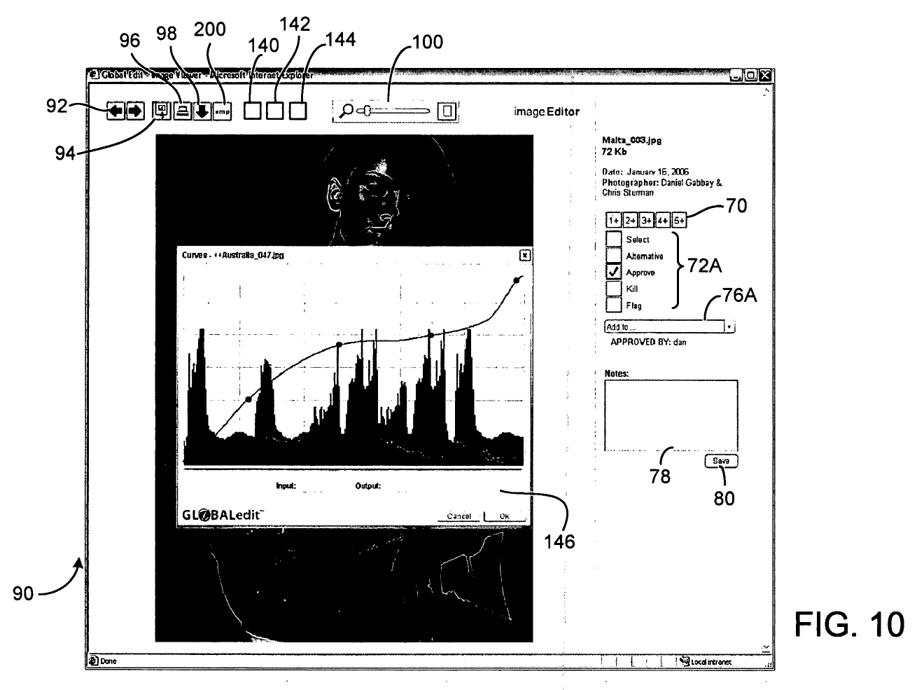

Some implementations of the image editor include various tools to facilitate color management and processing. As shown in FIG. 10, a first button 140 activates a color curves tool that allows the user to apply custom color curves to the images. Color settings can be saved so that they can be applied, for example, to a corresponding high resolution image file. When the user activates the color curve tool by clicking on the button 140, a pop-up window 146 appears to allow the user (e.g., a photographer) to make the desired changes using a graphic interface.

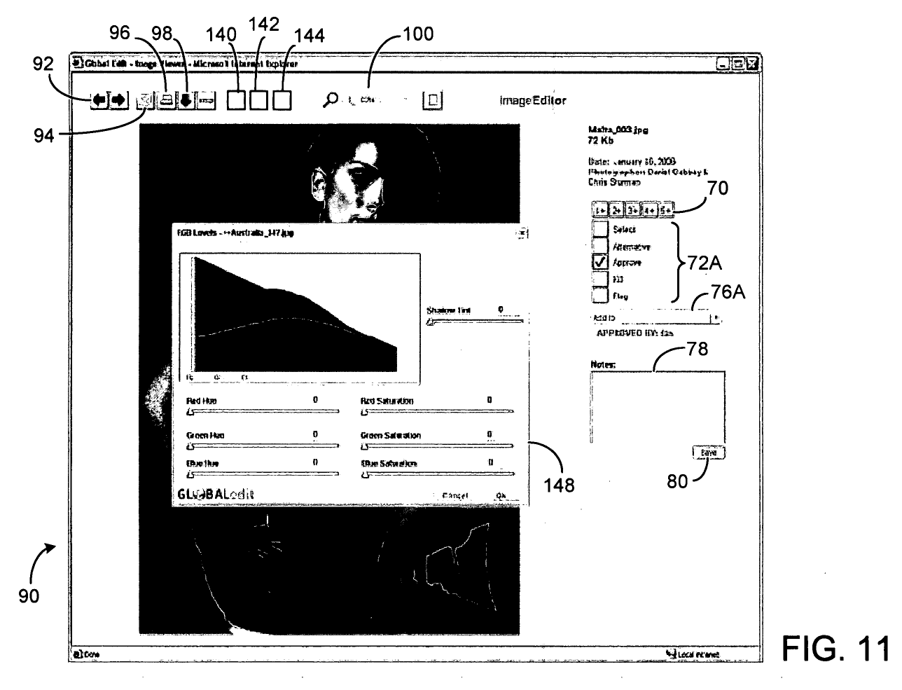

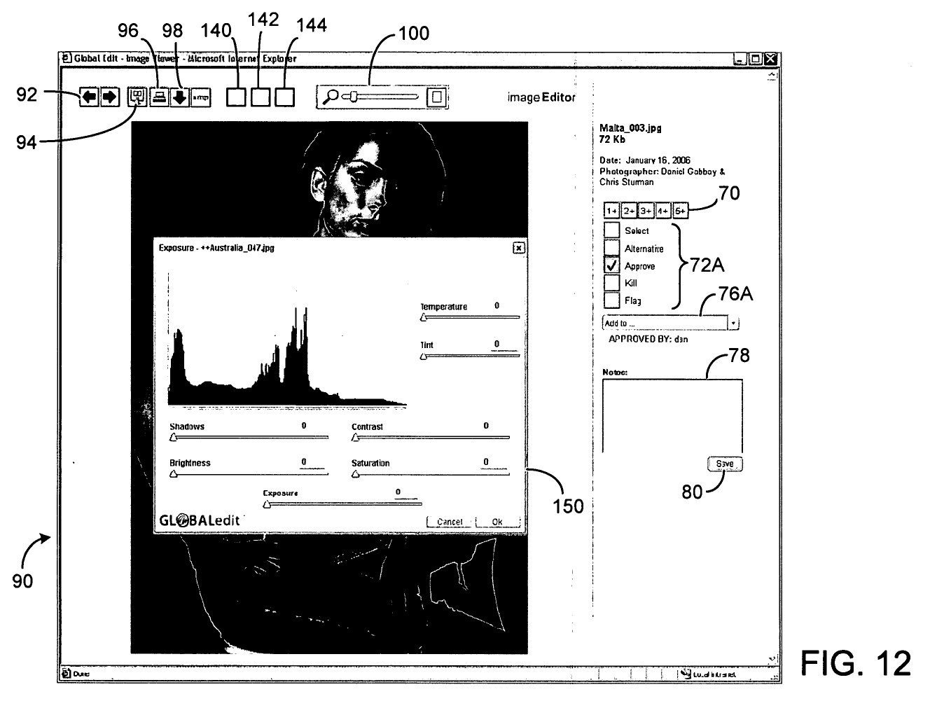

A second button 142 activates a color tool which allows a user to edit and preview red/green/blue (RGB) values using numerical and visual interfaces that appear in a pop-up window 148 (see FIG. 11). In the illustrated example, the user can set levels of hue and saturation for red, green and blue. The user also can set a level for the shadow tint. As before, the settings can be saved so that they can be applied, for example, to a corresponding high resolution image file. A third button 144 activates an exposure tool that allows a user to edit and adjust image exposure values using numerical and visual interfaces that appear in a pop-up window 150 (see FIG. 12). In the illustrated example, the user can set values for temperature, tint, shadows, brightness, contrast, saturation and exposure.

The image editor also allows the user to access the review and rating tools that are available in the image preview section 56 (see, e.g., FIG. 5 through 12).

The various tools and functions provided by the image editor can be accessed by a remote user (e.g., photographer, art direction, client), for example, through the Internet or other network.

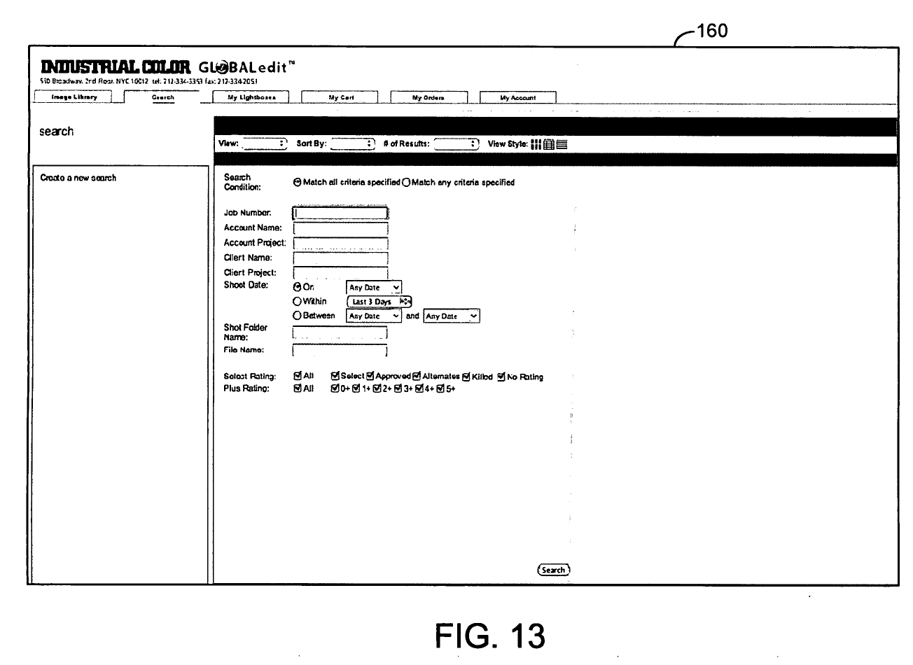

The user can access various search features by clicking the “Search” tab 44. The available search features are in addition to the capability to search using the search area 53 in the image library section 51. An example of a screen that appears when the user clicks the “Search” tab 44 is illustrated in FIG. 13. The system can execute an advanced search of the image files and related information based on multiple criteria entered by the user on the screen 160. The information that can be searched includes client metadata, as well as information entered by the client (e.g., text notes and ratings) and information in the client's “lightbox” folders. In the illustrated example, the user can select a search condition, for example, whether the system should look for matches that satisfy all the specified criteria or that satisfy any of the search criteria. Search criteria can include, for example, one or more of the following: job number, account name, account project, client name, client project, shoot date, shot folder name and file name. The search criteria also can include user-applied ratings. The particular search fields that are available may vary from client to client.

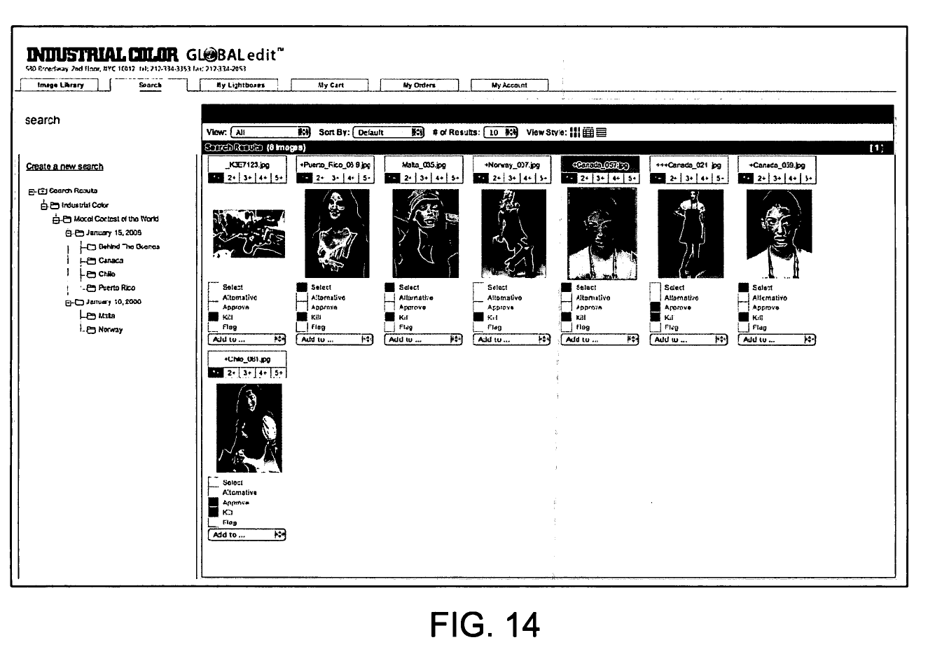

The system displays the search results that match the search criteria, and also displays the location of the results within the storage hierarchy. FIG. 14 illustrates an example of the search results.

User-Defined Lightboxes

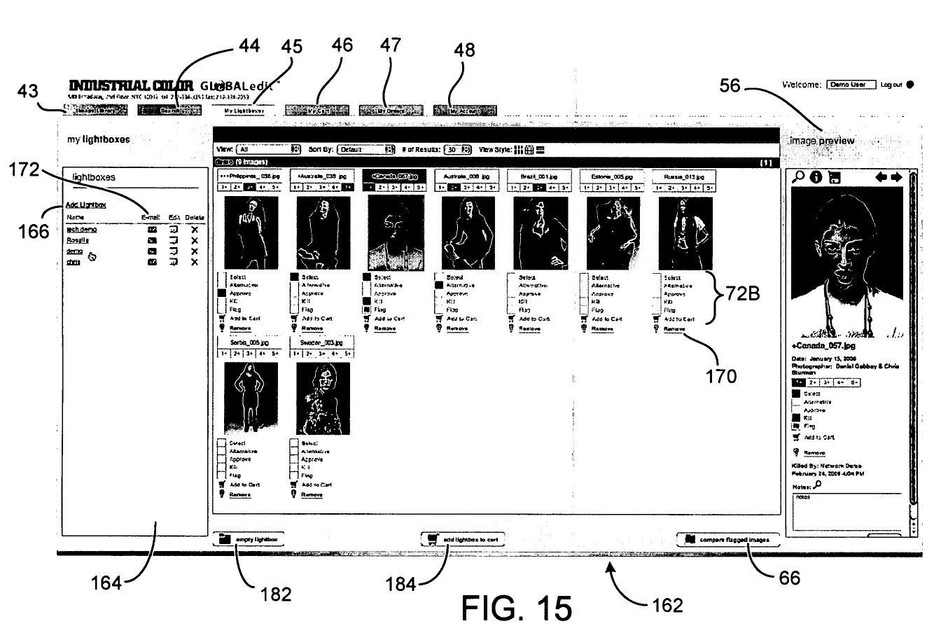

As noted above, a user (e.g., a client) can add individual images or collections of images to one or more user-defined folders each of which is called a “lightbox.” To create or access a lightbox, the user clicks on the “My Lightboxes” tab 45. An example of a screen 162 that appears when the tab 45 is selected is shown in FIG. 15. The left-hand section 164 of the screen 162 lists the client's current lightboxes and allows the user to create a new lightbox by clicking on the link 166 labeled “Add Lightbox.” The user can name the lightbox and can enter notes associated with an individual lightbox. As mentioned above, those notes can be searched using the search tools discussed above.

The center section 168 of the screen 162 displays the full gallery image viewing options. Thus, the images in the particular lightbox are displayed together with the ratings boxes (e.g., “select,” “alternate,” “approve” and “kill”) as well as the “flag” and “add to cart” options. If the user wishes to remove a particular image from the lightbox, the user would click on the corresponding icon 170 labeled “remove.” The entire contents of a lightbox can be emptied by clicking the “empty lightbox” button 182. Similarly, the entire contents of the lightbox can be added to the electronic shopping cart by clicking the “add lightbox to cart” button 184. The image preview section 56 as well as the image editor tool remain available from the screen 162.

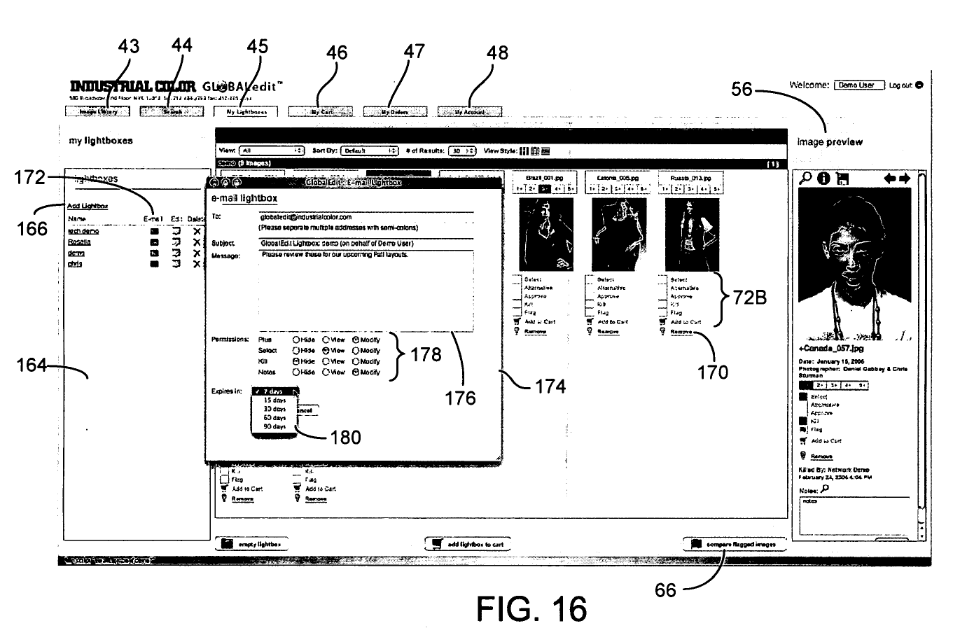

The screen 162 of FIG. 15 also allows the user to send the contents of a lightbox to a particular recipient by e-mail. To send a lightbox to another person, the user clicks the corresponding box under the e-mail icon 172 in the left-hand section 164 of the screen 162. A pop-up widow 174 (FIG. 16) appears and allows the user to enter the recipient's email address. The user also can enter information in the “subject” line and in a message area 176 of the window 174. In addition, the window 174 provides options for the user to determine what privileges 178 the recipient will have for the various rating options with respect to the contents of the lightbox. For example, the user can choose whether the recipient will be able to view the rating options (e.g., the “+” ratings, “select” and “kill”) and any notes associated with the images in the lightbox by clicking the appropriate circles labeled “hide” or “view” in the privileges section 178. In the event the recipient is granted permission to view the rating options and the notes, the user also can choose whether the recipient will have permission to edit that information by clicking the appropriate circles labeled “modify.” The user also can set the time frame during which the recipient will have access to the lightbox by selecting an time period from the drop-down menu 180. The system dynamically monitors and updates the contents of the lightbox in view of any changes that are made by the e-mail recipient. Thus, changes made by the recipient are reflected in the user's view of the lightbox as well.

Electronic Shopping Cart

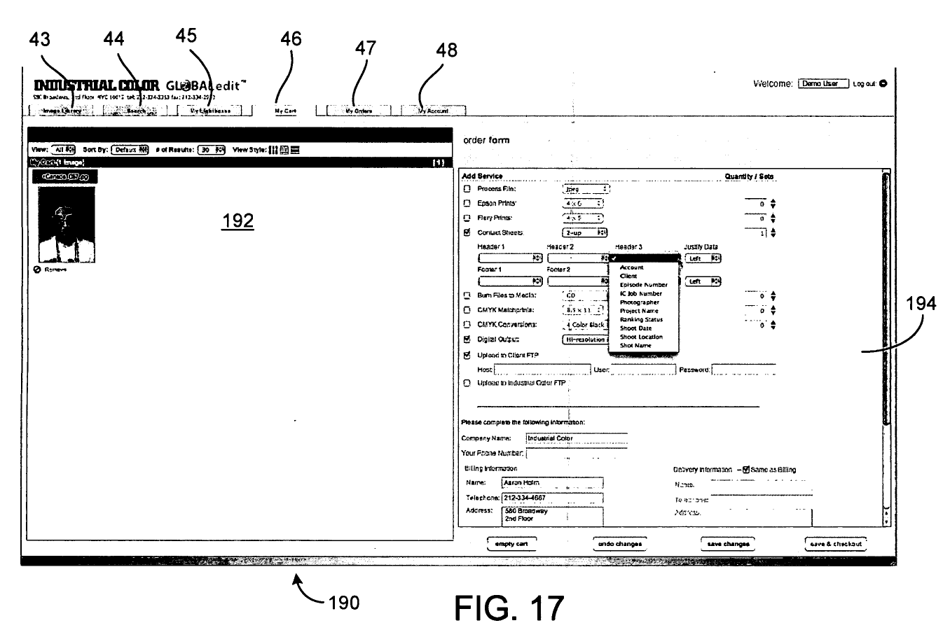

As also mentioned above, a user (e.g., a client) can add individual images or collections of images to an electronic shopping cart. The images can be added to shopping cart, for example, from the image library view (e.g., FIGS. 2, 3 or 4) or from individual lightboxes (e.g., FIG. 15). The entire contents of a lightbox can be added to the shopping cart with the single click of a on-screen button. To view the shopping cart, the user clicks the tab 46 (see, e.g., FIG. 2) labeled “My Cart.” An example of a screen 190 that appears when the “My Cart” tab 46 is selected is shown in FIG. 17. One section 192 of the screen shows the images that the user has placed in the shopping cart. Another section 194 displays an on-line order form to allow the user to place an order for specified services in connection with the images in the cart. Examples of services include: processing a file to multiple formats; providing print outputs or contact sheets with customized header and footer information; burning files to specified media; providing CMYK match prints and conversions; downloading high resolution source files directly from the system, assembling the images in the order into a single download file, and posting the file to a secure section of the site accessible through the “My Orders” tab 47; uploading files to a client or other FTP; retrieving files from archive and making the files available in a secure section of the site accessible through the “My Orders” tab 47. Other services also may be available.

When the client places an order, a detailed order preview is provided. Before the order is entered into the system for further processing, the system requests user confirmation based on the order preview. The system tracks all orders, which are stored by the system. The client can check its orders by clicking on the “My Orders” tab 47 (see, e.g., FIG. 2).

User's can view or change certain information relating to their account by clicking on the tab 48 labeled “My Account” (see, e.g., FIG. 2). For example, the user can change his system access password, profile and contact information.

Metadata Editor

As mentioned above, the system facilitates the storage of metadata associated with each digital image file or collection of image files. The system includes a custom metadata editor that allows users to attach metadata to each digital asset or collection of assets. The medatdata editor can be customized for individual clients to match their metadata schema. The custom client metadata integrates into the search functionality for the particular client's account, and all fields in the client's metadata schema can be made available as search filed options.

In some implementations, a metadata streaming technique is used to read metadata from, and write metadata to, matching metadata files for each image file on the system using standard or customized metadata schema. In one such technique, Extensible Markup Language (XML) message-oriented web methods are employed for saving and retrieving Extensible Metadata Platform (XMP) image metadata. The XML messages are designed in conjunction with the XML Schema Definition (XSD) schema. A web service drops a default template into a XMP folder, and loads a XML document representation of the template into memory. XML Path (XPATH) language can be used to populate values for each XML node in the template. The new XML document can be saved in a XMP folder with a .XMP extension using, for example, the image name as the filename. The information that described the client account linked to the XMP file is stored in the database along with information about where the XMP file is stored in the file system. When the user makes a request to edit specific image metadata, the web service retrieves the XMP file from the storage and loads the file into a XML document. The metadata web service then reads metadata items from the XML document and converts data into a web service dialect that the user interface for the image editor can interpret based on a defined XSD schema. The web service uses the Simple Object Access Protocol (SOAP) for messages and for passing the username of the user currently logged into the system website and for passing a secure token to authenticate each request to web service.

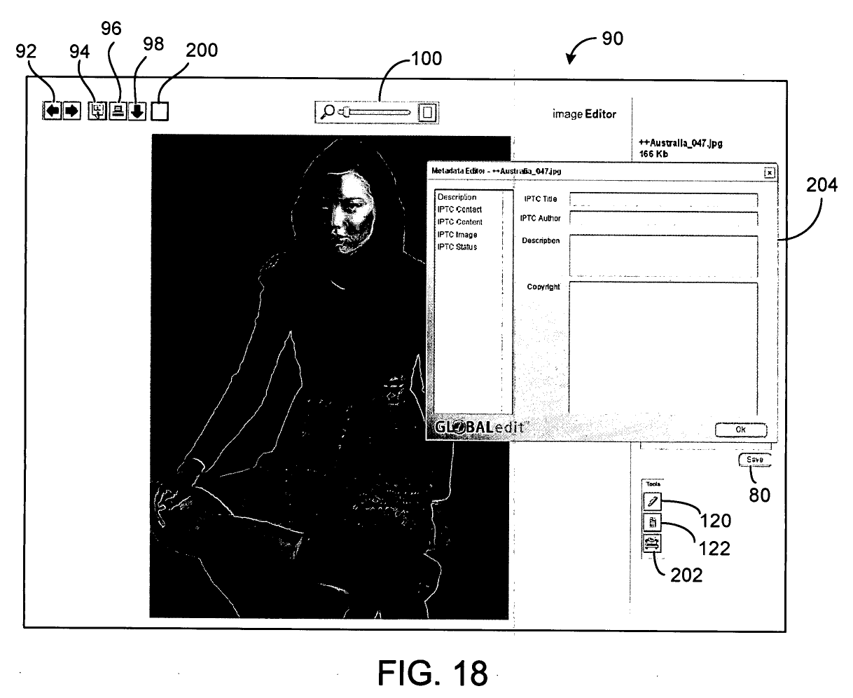

FIG. 18 illustrates a metadata editor interface. As shown in FIG. 18, the image editor can include an icon 200 that, when clicked, opens a dialog box 204 to allow a user (e.g., a photo-editor) to enter, modify and save metadata associated with the displayed image. Another icon 202 with the same functionality can be provided in the image preview section.

Administrative Users

As mentioned briefly above, certain users have administrative rights. Such users can create and edit account, each of which is assigned an account type. Examples of account types include agency and client accounts. Administrative users can edit the list of users that the system is programmed to recognize. Each user can be assigned a role which defines the access privileges and views of the system that the user has. The following chart lists examples of user-roles and corresponding privileges.

| User-role: | Privileges: |
|---|---|
| Network viewer | Can view non-killed digital asset only. |
| | Must explicitly be granted permissions to |
| | an asset collection. |
| Normal | Have normal access to the system. Must |
| | explicitly be granted permissions to an |
| | asset collection. |
| Super user | Have normal access to the system. Have |
| | immediate access to all asset collections |
| | uploaded to the system for the account of |
| | which they are a member. |
| Talent | Can mark assets as “killed” or “flagged” |
| | only. Have specialized functionality to |
| | submit reports. |
| Upload technician | Have normal access to the system. Can |
| | add jobs, users and accounts to the system |
| | using administrative tools. Cannot remove |
| | jobs, users or accounts from the system. |
| Viewer | Can view assets marked as “selected” only. |

Privileges can be assigned at the job level or sub-job level. Other implementations may define different or additional user-roles, each of which may have a different set of privileges.
Uploading Digital Assets to the System

Administrative users also can create new jobs on the system and upload digital assets from available storage locations. Each job is assigned to an active account on the system.

The system allows live job updates and, in particular, allows jobs to be updated in real time from a remote location. For example, once a job has been added to the system, an administrative user can connect to the source media location via FTP and add assets (e.g., digital image files) into the job. Other users, such as clients, can view the added assets as they are uploaded, and full system functionality is available as soon as the asset is uploaded to the system.

Uploading a set of digital assets (e.g., image files) to the system, for example, from a production environment, can be performed over the Internet or other network and can be performed in real-time as the images are captured by the digital photographic equipment. In a particular implementation, an administrator can select source media from an available network storage and apply format, resolution and metadata transformations to all images in the subdirectories of the selected location. The transformed media are provided as output to an output location on an available network storage. Examples of transformations that are available include scaling and converting the digital files to a low resolution format; scaling and converting the files to a high resolution format; copying XMP metadata; embedding metadata using a template; extracting metadata and providing output to metadata files. The transformations can be executed, for example, on a system server as an application service.

Multiple transformation jobs can be submitted simultaneously by different administrators. In that case, the jobs are entered into a job manager queue. Full logs are available for each job detailing the source and destination of the assets and the transformations that were applied to them. Once the transformation is complete, the job is synchronized with the system. As part of the synchronization, each asset is pre-formatted into multiple versions to provide optimal load time for the user. Job data is written and stored in a system database and default privileges are assigned by the system.

The foregoing features provide the ability to ingest and display flexible directory structures that contain digital images or other digital assets. Thus, the system is capable of uploading digital files from a plurality of different types of data storage structures. Thus, snapshots can be taken of client media, for example, via the web and updated whenever desired.

Example Application: Photo Edits

A particular application of the foregoing system is for photo edits. The system can be used to match the collaborative workflow requirements of various personnel involved in a photo shoot and subsequent processing.

The following illustrates an example of the how the system can be used. Initially, an administrator adds a job to the system, as well as any associated accounts and members. The job would appear in the job tree 52 (see, e.g., FIG. 1). Images from a photo shoot then can be uploaded to the system. The images can be uploaded, for example, to a FTP server by way of a remote upload (e.g., over the Internet). The images then can be accessed by logging into the system website. The system can use a mapping between the FTP upload point and the web site upload point to gain access to the images. Alternatively, the images can be uploaded directly to the system, for example, by a network upload (e.g., over a local area network). In other implementations, the images can be uploaded by a live upload over the Internet or a local area network, which allows the images to be uploaded substantially in real time. The images and associated directories can be uploaded in a either a structured or unstructured manner.

Once the images are available on the system, a photographer art director, for example, can access the images by logging into the website and locating the corresponding job in the job tree 52 (see, e.g., FIG. 2). The art director can open the files for the particular shoot date and shot, and can view the images, for example, in the image gallery section 54. That allows the art director to view a large number of images quickly. Particular images can be opened in the image editor to allow a closer look at details and to add annotations or other markings. The art can mark various images as “selected,” “killed” or “alternate.” The art director also can add notes about particular images in the image preview section 56. Upon closing the image editor pop-up window 90 and returning to a view of the image gallery 54, the art director can filter the images so that only images that meet specified criteria (e.g., “selected” images) are displayed in the image gallery 54. The art director may take a closer look at any of the images and may remove some of the images by changing their status, for example, from “selected” to “killed.”

Upon completing the image editing process, the art director may create a lightbox folder and add the selected images to the lightbox. The contents of the lightbox can be sent as an attachment to an e-mail message to another person, such as a creative director, for review and approval.

Upon receiving the e-mail with the attached lightbox, the creative director can open the lightbox and click through the images. Particular images can be opened in the image editor pop-up window 90 for closer review. The creative director can add additional notes to the images and mark selected images for approval. The system dynamically monitors and updates the contents of the lightbox in view of any changes that are made by the creative director.

The low resolution files of the approved images then can be downloaded for layout, and the approved images can be added to an electronic shopping cart. A purchase order can be created and submitted for high resolution files.

Example Application: On-Line Publicity Talent Approvals

Another application of the system is for on-line publicity talent approvals. The system can be used to match workflow requirements in the entertainment industry.

Users who have been assigned the role of “talent” can view jobs and shots that are stored by the system and with respect to which the user has been granted permission. Within a particular shot, the talent user can mark an asset (e.g., image file) as “approved” or as “killed” (to indicate that the asset is not approved and may not be used for marketing or public relations purposes). The system may give the talent user a limited time to complete the approval process and may limit the number of image files that may be “killed” by the user. Such limits can be set by an administrator.

Once the talent user completes the review, the user can submit an on-line request, which generates a report in the form, for example, of a PDF file, for example, listing all files in the shot and identifies which files have been approved and which have been “killed.” The report also can indicate which user took the specified action for each image file, as well as the date of the action. The report, which can be included as an attachment to an e-mail message, can serve as a paper trail in the event a dispute arises as to what action was to be taken with respect to a particular image file.

Example Application: Photographer's Sample Portfolio

The system also can be used to facilitate a photographer's creating a sample portfolio. For example, the photographer can review images from one or more shoot dates and can add selected images to a portfolio lightbox, which then can be forwarded to various recipients who are granted viewing permission only. Thus, the system can be used as a marketing tool.

A number of implementations of the invention have been described. Nevertheless, it will be understood that various modifications may be made without departing from the spirit and scope of the invention. Accordingly, other implementations are within the scope of the following claims.

What is claimed is:

1. A digital asset management system comprising:
a file storage module to store digital asset files;
a data upload module to upload digital asset files for storage in the file storage module; and
a user interface module to give users selective access, through a computer network, to digital asset files stored in the file storage module, wherein the user interface module allows various users to take specified actions with respect to the digital asset files depending on respective privileges granted to each user and stored by the system.

2. The digital asset management system of claim 1 wherein the digital asset files comprise digital image files.

3. The digital asset management system of claim 2 wherein the user interface module allows various users to view, search, sort, rank, compare side-by-side, edit or annotate the digital image files depending on respective privileges granted to each user and stored by the system.

4. The digital asset management system of claim 3 wherein the system is configured to store rankings, edits and annotations made by users to the digital image files.

5. The digital asset management system of claim 4 wherein rankings, edits or annotations made by a first user are made available for viewing, through the user interface module, by another user who has appropriate privileges.

6. The digital asset management system of claim 2 wherein the user interface module is configured to display a screen comprising:
an image library to allow the user to navigate through collections of image files;
an image gallery in which a collection of image files selected by the user from the image library are displayed; and
an image preview section for displaying a larger size view of a particular one of the image files selected by the user from among the image files displayed in the image gallery.

7. The digital asset management system of claim 2 wherein the user interface module is configured to cause selected digital image files to be displayed on a user's display screen in accordance with a user-selected format, wherein the format is selected from among at least the following available options: a thumbnail view of the selected digital image files, a listing of records corresponding to the selected digital image, and a view of the selected digital image files that includes associated metadata for each of the displayed files.

8. The digital asset management system of claim 7 wherein the user interface module is configured to display a subset of image files based on a user-selected filter applied to a collection of image files selected by the user.

9. The digital asset management system of claim 2 wherein the user interface module is configured to display editing tools that allow a user to mark-up a displayed image and to enter text notes on a displayed image, and wherein the system is configured to store such mark-ups and text notes and to make them available for viewing through the user interface module by another user who has appropriate privileges.

10. The digital asset management system of claim 9 wherein the editing tools allow the user to select a color and brush size for the mark-ups, and wherein the system is configured to apply the color and brush size selected by the user to the displayed image.

11. The digital asset management system of claim 9 wherein the user interface module includes a magnification tool that allows the user to select a scaled view of the displayed image, wherein the size of the mark-ups and text notes scale with the size of the displayed image as the user uses the magnification tool.

12. The digital asset management system of claim 9 wherein the system is configured to save the mark-ups and text notes and to apply them to a high resolution image file corresponding to the displayed image in response to input from the user.

13. The digital asset management system of claim 2 wherein the user interface module is configured to display color management tools to allow a user to adjust one or more of the following with respect to a displayed image: color curves, RGB values and image exposure values, and
wherein the system is configured to modify the displayed image in accordance with user-specified changes based on the color management tools.

14. The digital asset management system of claim 13 wherein the system is configured to save color curves, RGB values and image exposure values entered by the user and to apply them to a high resolution image file corresponding to the displayed image in response to input from the user.

15. The digital asset management system of claim 2 wherein the user interface module is configured to display a metadata editor to allow a user to associate metadata with a particular image file, wherein the system is configured to store the metadata and apply the metadata to a high resolution image file corresponding to the particular image file.

16. The digital asset management system of claim 2 wherein the user interface module is configured to allow the user to store one or more user-selected image files in a user-defined electronic folder.

17. The digital asset management system of claim 16 wherein the user interface module is configured to display a pop-up window in response to user-input to allow the user to send contents of the user-defined folder by e-mail to a third-party.

18. The digital asset management system of claim 17 wherein the pop-up window provides options for the user to define what privileges the third-party will have with respect to the contents of the folder.

19. The digital asset management system of claim 16 wherein the system is configured to monitor and update contents of the folder dynamically in accordance with changes made by the third-party.

20. The digital asset management system of claim 2 wherein the user interface module is configured to allow the user to store one or more selected image files in an electronic shopping cart and to order post-production services related to the selected images.

21. The digital asset management system of claim 2 wherein the user interface module is configured to allow user to view enlarged versions of user-selected image files in a side-by-side comparison mode.

22. The digital asset management system of claim 21 wherein the user interface module includes a loupe tool to allow the user to view an enlarged version of a selected portion of one of the selected image files in the side-by-side comparison mode.

23. The digital asset management system of claim 2 wherein the user interface module is configured to download one or more user-selected image files from the file storage module to a local cache associated with the user in response to a request from the user.

24. The digital asset management system of claim 2 wherein the user interface module includes a metadata editor interface to allow a user to enter metadata for storage by the system in association with a specified image.

25. The digital asset management system of claim 24 wherein the system is configured to implement an Extensible Markup Language (XML) message-oriented web technique for saving and retrieving Extensible Metadata Platform (XMP) image metadata.

26. The digital asset management system of claim 2 wherein the data upload module is configured to upload a set of digital image files over a network in real-time as the digital image files are captured by digital photographic equipment.

27. The digital asset management system of claim 26 including a data pre-processing module to apply user-selected format, resolution and metadata transformations to user-selected digital image files.

28. The digital asset management system of claim 27 wherein available transformations in the data pre-processing module include scaling and converting the digital image files to a low resolution format; scaling and converting the digital image files to a high resolution format; copying XMP metadata; embedding metadata using a template; and extracting metadata and providing output to metadata files.

29. The digital asset management system of claim 27 wherein the data pre-processing module is configured to synchronize the uploaded digital image files according to one or more predetermined formats.

30. The digital asset management system of claim 26 wherein the system is configured for uploading digital files from a plurality of different types of data storage structures.

31. The digital asset management system of claim 1 wherein the user interface module is accessible through an Internet website.

32. The digital asset management system of claim 1 wherein the user interface module is configured to allow a specified user to access and review a set of digital images over a network and to mark individual images in the set as approved or disapproved for use in marketing or public relations.

33. The digital asset management system of claim 32 wherein the system is configured to limit the time during which the specified user can mark the images as approved or disapproved.

34. The digital asset management system of claim 32 wherein the system is configured to limit the number of images in the set that the specified user can mark as disapproved.

35. The digital asset management system of claim 32 wherein the system is configured to generate a report in response to a user-request, wherein the report lists the images in the set and identifies which images have been marked as disapproved.

36. A computer-implemented method comprising:
storing digital asset files;
displaying graphical user interfaces that allow various users to take specified actions with respect to the digital asset files depending on respective privileges granted to each user.

37. The method of claim 36 wherein the digital asset files comprise digital image files.

38. The method of claim 37 including displaying graphical user interfaces that allow various users to view, search, sort, rank, compare side-by-side, edit or annotate the digital image files depending on respective privileges granted to each user.

39. The method of claim 38 including storing rankings, edits and annotations made by users to the digital image files.

40. The method of claim 39 including displaying rankings, edits or annotations made by a first user to another user who has appropriate privileges.

41. The method of claim 37 including displaying a screen comprising:
an image library to allow the user to navigate through collections of image files;
an image gallery in which a collection of image files selected by the user from the image library are displayed; and
an image preview section for displaying a larger size view of a particular one of the image files selected by the user from among the image files displayed in the image gallery.

42. The method of claim 37 including displaying selected digital image files in accordance with a user-selected format, wherein the format is selected from among at least the following available options: a thumbnail view of the selected digital image files, a listing of records corresponding to the selected digital image, and a view of the selected digital image files that includes associated metadata for each of the displayed files.

43. The method of claim 42 including displaying a subset of image files based on a user-selected filter applied to a collection of image files selected by the user.

44. The method of claim 37 including:
displaying editing tools that allow a user to mark-up a displayed image and to enter text notes on a displayed image;
storing such mark-ups and text notes; and
making the stored mark-ups and text notes available for viewing by another user who has appropriate privileges.

45. The method of claim 44 wherein the editing tools allow the user to select a color and brush size for the mark-ups, wherein the method includes applying the color and brush size selected by the user to the displayed image.

46. The method of claim 44 including:
displaying a magnification tool that allows the user to select a scaled view of the displayed image, and
scaling the size of the mark-ups and text notes with the size of the displayed image as the user uses the magnification tool.

47. The method of claim 44 including:
saving the mark-ups and text notes; and
applying them to a high resolution image file corresponding to the displayed image in response to input from the user.

48. The method of claim 37 including:
displaying color management tools to allow a user to adjust at least one of color curves, RGB values or image exposure values with respect to a displayed image; and
modifying the displayed image in accordance with user-specified changes based on the color management tools.

49. The method of claim 48 including:
saving color curves, RGB values and image exposure values entered by the user; and
applying the saved color curves, RGB values and image exposure values to a high resolution image file corresponding to the displayed image in response to input from the user.

50. The method of claim 37 including:
displaying a metadata editor to allow a user to associate metadata with an image file;
storing metadata entered by a user and associating the metadata with a particular image file; and
applying the metadata to a high resolution image file corresponding to the particular image file.

51. The method of claim 37 displaying a graphical user interface that allows a user to store one or more user-selected image files in a user-defined folder.

52. The method of claim 51 including displaying a pop-up window in response to user-input to allow the user to send contents of the user-defined folder by e-mail to a third-party.

53. The method of claim 52 wherein the pop-up window provides options for the user to define what privileges the-third party will have with respect to the contents of the folder.

54. The method of claim 37 including:
storing one or more selected image files in an electronic shopping cart; and
transmitting an order for post-production services related to the selected images.

55. The method of claim 37 displaying enlarged versions of user-selected image files in a side-by-side comparison mode.

56. The method of claim 55 including displaying an enlarged version of a user-selected portion of one of the selected image files in the side-by-side comparison mode.

57. The method of claim 37 including downloading one or more user-selected image files to a local cache associated with the user in response to a request from the user.

58. The method of claim 37 including storing metadata in association with a specified image.

59. The method of claim 58 including implementing an Extensible Markup Language (XML) message-oriented web technique for saving and retrieving Extensible Metadata Platform (XMP) image metadata.

60. The method of claim 37 including uploading a set of digital image files over a network in real-time as the digital image files are captured by digital photographic equipment.

61. The method of claim 60 including applying user-selected format, resolution and metadata transformations to user-selected digital image files.

62. The method of claim 61 including applying at least one of the following transformations: scaling and converting the digital image files to a low resolution format; scaling and converting the digital image files to a high resolution format; copying XMP metadata; embedding metadata using a template; and extracting metadata and providing output to metadata files.

63. The method of claim 61 including synchronizing the uploaded digital image files according to one or more predetermined formats.

64. The method of claim 36 including displaying the graphical user interfaces from an Internet website.

65. The method claim 37 including:
allowing a specified user to have access to a set of digital images over a network and to mark individual images in the set as approved or disapproved for use in marketing or public relations; and
storing information as to whether the specified user marked each individual image as approved or disapproved.

66. The method of claim 65 including limiting the time during which the specified user can mark the images as approved or disapproved.

67. The method of claim 65 including limiting the number of images in the set that the specified user can mark as disapproved.

68. The method of claim 65 including generating a report in response to a user-request, wherein the report lists the images in the set and identifies which images have been marked as disapproved.

69. An article comprising a machine-readable medium that stores machine-executable instructions for causing a machine to:
store digital asset files;
display graphical user interfaces that allow various users to take specified actions with respect to the digital asset files depending on respective privileges granted to each user.

70. The article of claim 69 wherein the digital asset files comprise digital image files.

71. The article of claim 70 wherein the medium stores machine-executable instructions for causing the machine to display graphical user interfaces that allow various users to view, search, sort, rank, compare side-by-side, edit or annotate the digital image files depending on respective privileges granted to each user.

72. The article of claim 71 wherein the medium stores machine-executable instructions for causing the machine to store rankings, edits and annotations made by users to the digital image files.

73. The article of claim 72 wherein the medium stores machine-executable instructions for causing the machine to display rankings, edits or annotations made by a first user to another user who has appropriate privileges.

74. The article of claim 70 wherein the medium stores machine-executable instructions for causing the machine to display a screen comprising:
an image library to allow the user to navigate through collections of image files;
an image gallery in which a collection of image files selected by the user from the image library are displayed; and
an image preview section for displaying a larger, size view of a particular one of the image files selected by the user from among the image files displayed in the image gallery.

75. The article of claim 70 wherein the medium stores machine-executable instructions for causing the machine to display selected digital image files in accordance with a user-selected format, wherein the format is selected from among at least the following available options: a thumbnail view of the selected digital image files, a listing of records corresponding to the selected digital image, and a view of the selected digital image files that includes associated metadata for each of the displayed files.

76. The article of claim 75 wherein the medium stores machine-executable instructions for causing the machine to display a subset of image files based on a user-selected filter applied to a collection of image files selected by the user.

77. The article of claim 70 wherein the medium stores machine-executable instructions for causing the machine to:
display editing tools that allow a user to mark-up a displayed image and to enter text notes on a displayed image;
store such mark-ups and text notes; and
make the stored mark-ups and text notes available for viewing by another user who has appropriate privileges.

78. The article of claim 77 wherein the editing tools allow the user to select a color and brush size for the mark-ups, wherein the method includes applying the color and brush size selected by the user to the displayed image.

79. The article of claim 77 wherein the medium stores machine-executable instructions for causing the machine to:
display a magnification tool that allows the user to select a scaled view of the displayed image, and
scale the size of the mark-ups and text notes with the size of the displayed image as the user uses the magnification tool.

80. The article of claim 77 wherein the medium stores machine-executable instructions for causing the machine to:
save the mark-ups and text notes; and
apply the mark-ups and text notes to a high resolution image file corresponding to the displayed image in response to input from the user.

81. The article of claim 70 wherein the medium stores machine-executable instructions for causing the machine to:
display color management tools to allow a user to adjust at least one of color curves, RGB values or image exposure values with respect to a displayed image; and
modify the displayed image in accordance with user-specified changes based on the color management tools.

82. The article of claim 81 wherein the medium stores machine-executable instructions for causing the machine to:
save color curves, RGB values and image exposure values entered by the user; and
apply the saved color curves, RGB values and image exposure values to a high resolution image file corresponding to the displayed image in response to input from the user.

83. The article of claim 70 wherein the medium stores instructions for causing the machine to:
display a metadata editor to allow a user to associate metadata with an image file;
store metadata entered by a user and associating the metadata with a particular image file specified by the user; and
apply the metadata to a high resolution image file corresponding to the particular image file.

84. The article of claim 70 wherein the medium stores machine-executable instructions for causing the machine to display a graphical user interface that allows a user to store one or more user-selected image files in a user-defined folder.

85. The article of claim 84 wherein the medium stores machine-executable instructions for causing the machine to display a pop-up window in response to user-input to allow the user to send contents of the user-defined folder by e-mail to a third-party.

86. The article of claim 85 wherein the pop-up window provides options for the user to define what privileges the-third party will have with respect to the contents of the folder.

87. The article of claim 70 wherein the medium stores machine-executable instructions for causing the machine to:
store one or more selected image files in an electronic shopping cart; and
transmit an order for post-production services related to the selected images.

88. The article of claim 70 wherein the medium stores machine-executable instructions for causing the machine to display enlarged versions of user-selected image files in a side-by-side comparison mode.

89. The article of claim 88 wherein the medium stores machine-executable instructions for causing the machine to display an enlarged version of a user-selected portion of one of the selected image files in the side-by-side comparison mode.

90. The article of claim 70 wherein the medium stores machine-executable instructions for causing the machine to download one or more user-selected image files to a local cache associated with the user in response to a request from the user.

91. The article of claim 70 wherein the medium stores machine-executable instructions for causing the machine to store metadata in association with a specified image.

92. The article of claim 91 wherein the medium stores machine-executable instructions for causing the machine to implement an Extensible Markup Language (XML) message-oriented web technique for saving and retrieving Extensible Metadata Platform (XMP) image metadata.

93. The article of claim 70 wherein the medium stores machine-executable instructions for causing the machine to upload a set of digital image files over a network in real-time as the digital image files are captured by digital photographic equipment.

94. The article of claim 93 wherein the medium stores machine-executable instructions for causing the machine to apply user-selected format, resolution and metadata transformations to user-selected digital image files.

95. The article of claim 94 wherein the medium stores machine-executable instructions for causing the machine to apply at least one of the following transformations: scaling and converting the digital image files to a low resolution format; scaling and converting the digital image files to a high resolution format; copying XMP metadata; embedding metadata using a template; and extracting metadata and providing output to metadata files.

96. The article of claim 94 wherein the medium stores machine-executable instructions for causing the machine to synchronize the uploaded digital image files according to one or more predetermined formats.

97. The article of claim 69 wherein the medium stores machine-executable instructions for causing the machine to display the graphical user interfaces from an Internet website.

98. The article of claim 70 wherein the medium stores instructions for causing the machine to:
allow a specified user to have access to a set of digital images over a network and to mark individual images in the set as approved or disapproved for use in marketing or public relations; and
store information as to whether the specified user marked each individual image as approved or disapproved.

99. The article of claim 98 wherein the medium stores instructions for causing the machine to:
limit the time during which the specified user can mark the images as approved or disapproved.

100. The article of claim 98 wherein the medium stores instructions for causing the machine to:
limit the number of images in the set that the specified user can mark as disapproved.

101. The article of claim 98 wherein the medium stores instructions for causing the machine to:
generate a report in response to a user-request, wherein the report lists the images in the set and identifies which images have been marked as disapproved.
